(19) United States
(12) Patent Application Publication
(10) Pub. No.: US 2008/0082395 A1
(43) Pub. Date: Apr. 3, 2008

(54) VIRTUAL CLOSET

(76) Inventors: Olivia Mandell Shulman, Las Vegas, NV (US); Dean Shulman, Las Vegas, NV (US); Brian Grady, Las Vegas, NV (US)

Correspondence Address: DLA PIPER US LLP, P. O. BOX 9271, RESTON, VA, 20195, US

(21) Appl. No.: 11/832,050

(22) Filed: Aug. 1, 2007

Related U.S. Application Data
(60) Provisional application No. 60/822,719, filed on Aug. 17, 2006.

(51) Int. Cl. G06Q 30/00; G06F 17/30; G06F 17/40

(52) U.S. Cl. 705/10; 705/14

(57) ABSTRACT

A method and system are disclosed that provide a forum for shopping between customers and merchants within a host website connected on a computer network. Merchants and customers are registered within the host website, and the products of registered merchants are loaded onto the host website. Registered customers shop exclusively on the host website such that the shopping is configured to be based on the loaded products of registered merchants.

### RELATED APPLICATIONS

The present application claims the benefit of U.S. Provisional Application No. 60/822,719, filed Aug. 17, 2006, which is incorporated by reference herein in its entirety.

### FIELD OF THE INVENTION

The present invention relates to method and system of permitting a shopper using a web based tool to select from available clothing articles and to create a personal selection of those items to their own private shopping list within a web page.

### BRIEF DESCRIPTION OF THE DRAWINGS

Reference is made to the attached drawing, wherein elements having the same reference designations represent like elements throughout and wherein:

FIG. 1A illustrates a block diagram of a virtual closet system that permits registered merchants of a host website to load their products into a catalogue provided by the host website.

FIG. 1B illustrates a block diagram of the method for non-registered merchants to create a membership account within a host website in order to become registered merchants with the host website.

FIG. 2 illustrates a block diagram for implementing the virtual closet method and system.

FIG. 3 illustrates an interface for entering personal information in order for a customer to login or sign up with the virtual closet host website.

FIG. 4 illustrates an interface for entering data to initiate signing up a new customer.

FIG. 5 illustrates an interface for receiving profile information related to a new customer registering with the host website.

FIG. 6 illustrates an exemplary virtual closet interface related to a male customer based on profile information entered during signup.

FIGS. 7-9 illustrate exemplary mix-n-match interfaces containing products that permit each to be clicked, held and dragged around the interface so as to be combined with other products to determine whether the various products match with one another.

FIG. 10 illustrates a merchant login interface that provides a login interface to registered merchants.

FIG. 11 illustrates a merchant area main page interface that provides summarized information of the products of a registered merchant registered with the host website.

FIGS. 11(a)-11(e) illustrate examples of interfaces a merchant sees when he/she clicks on information related to account details, cap and payment plan, contact details, store information and store links, respectively.

FIG. 12 illustrates an example of a product tracking interface that enables merchants to interactively track the number of clicks received by their products on to the host website.

### DETAILED DESCRIPTION OF SEVERAL EMBODIMENTS

The embodiments described below are methods and systems involving a web based software tool that allows a user of a host website employing the tool to select items from approved merchants and save an image and description of desired items in their “virtual closet” for action on those saved items at any time desired by the user. As used herein, the term “virtual closet” refers to a storage area that enables a customer to store products previously browsed wherein the customer may purchase such stored products at a later desired time. The user can pull information from within the host website, and store such information in the users virtual closet. The user is then able to recall the information and image associated with such information at a later desired time.

The web-based software tool may be developed with programming languages such as PHP and SQL. The web-based tool is used to present information to a user and to provide choices to the user as he/she dynamically interacts with the information. Of course, other programming languages may be employed. For example, ASP programming language could be used, instead of PHP, to write scripts that interact with a database associated with the present invention. The software tools are designed to facilitate a user's efficient interaction with a database, and to store and present information to the user via a customer friendly graphical user interface (GUI). The database is used to store information and choices associated with users and customers.

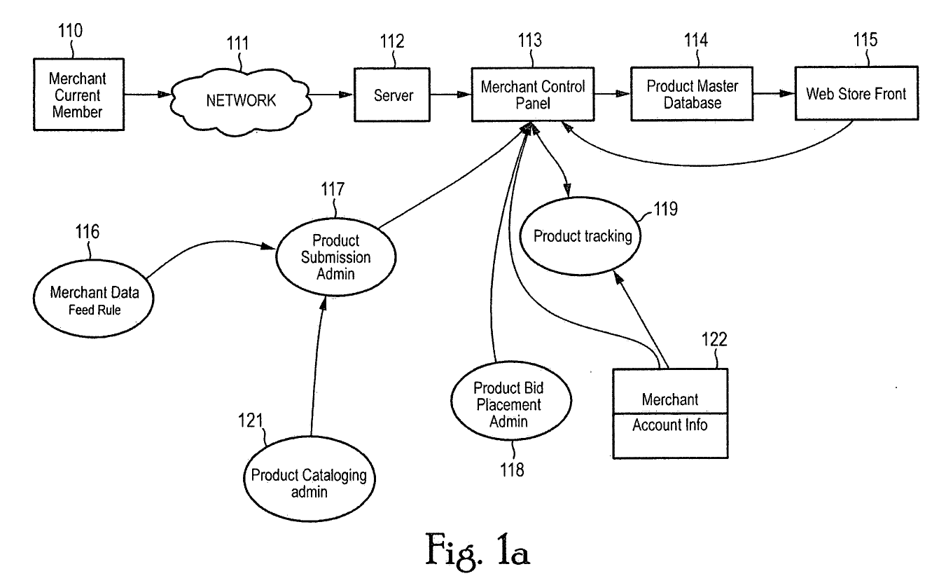

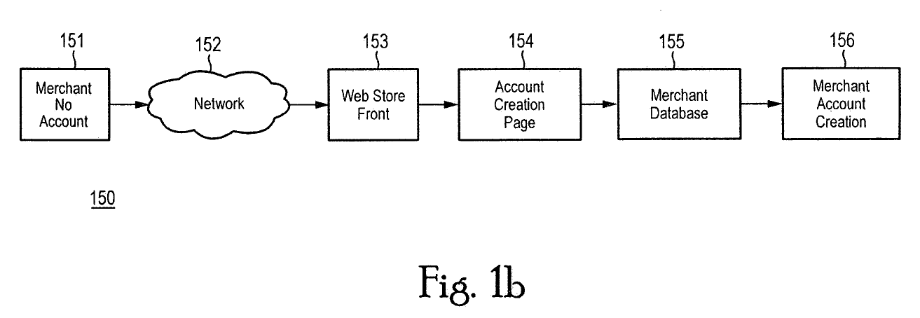

FIG. 1A illustrates a merchant system 100 that allows registered merchants or vendors of a host website to load their products into catalogues provided by the host website. Such a host website provides a customer with a forum to products of registered merchants/vendors. The registered merchants catalog their products via an access only system, which then allows a customer to collect and review these products for purchase or for matching with other products. Products that are made available for transactions are limited exclusively to those products in a registered merchant's catalog on the host website. When the merchant's products have been fully loaded onto the host website, the web tool allows a shopper using the search engine provided by the host website to select from available products, for example, clothing articles, and then create a personal selection of those items to their own private web page or “shopping list.” No items from outside the host website are permitted to be added to the user's personal shopping list. However, different registered merchants of the host website may add items or products to a registered user's shopping list. The shopping list allows the user to assemble wardrobes within their respective virtual closet created on the host website by moving items into a virtual closet wherein the user is able to match the item and colors of the products. Thus, the user is provided with an intelligent selection mechanism instead of guessing whether the items match.

Merchant system 100 enables merchant current member 110 to connect to merchant control panel 113 via network 111 and web server 112. Network 111 may be any collection and arrangement of hardware and/or software allowing electronic communications between components in merchant system 100. For example, network 111 may be one or a collection of components associated with the public switched telephone network, local area networks, wide area networks, a global computer network such as the Internet, the World Wide Web, or any other suitable wireline or wireless communications technology. In merchant system 100, the merchant control panel 113 provides a login interface to registered merchants 110. When a registered merchant enters required information needed to successfully log on to the merchant system 100, the information is transmitted via the network 111 and authenticated by server 112. By successfully logging on to the system after authentication by server 112, merchant control panel 113 is enabled by server 112 to provide an interface for product submission. In an embodiment of the invention, a registered merchant may use an excel spreadsheet via merchant data feed file 116 to categorize information associated with his/her various products. All merchant products that are offered for sale to customers are loaded into the host website prior to any transaction. This ensures that customers of the host website access the merchants' products exclusively via the host website, and not by a link that is connected to merchants' personal websites located external to the host website.

In an embodiment, product submission administrator 117 uploads the merchant's product information associated with the excel spreadsheet, into the merchant control panel 113. Access to the merchant control panel 113 may be controlled by a product catalog administrator 121 who assigns product categories to products of registered merchants. These products are then uploaded by the product submission administrator 117 to the merchant control panel 113. Product bid placement administrator 118 controls how customers view various products that are placed in the host website system. Merchants bid on advertisement placements. Customers are exposed to the highest bids in order of the bids amounts, from the highest to the lowest amounts. The bidding process used in this merchant system 100 is well known in the art.

In an embodiment, product tracking 119 keeps track of the number of clicks each product, loaded on to the merchant system 100, has received. Merchants are billed by the virtual closet host website based on the number of clicks each merchant's product receives. A pay-per-click system that is based on the bid amount may be used by the host website. Merchant account information 122 keeps track of information contained in product tracking 119 as well as pertinent personal information related to each merchant such as billing addresses.

Product master database 114 serves to hold information related to the various merchants products. Such merchant product information may include the image of the product, the product description in terms of size, color or the like. The product master database 114 may arrange the products based on the bid amounts that have been placed by the merchants. The product master database 114 is connected to web store front 115, which represents a graphical user interface (GUI) that the user sees. The GUI enables users to log on to the host website system wherein the user enters information such as username, password and/or email in order to gain access to the virtual closet system.

FIG. 1B illustrates in block diagram form the method for non-registered merchants to create membership accounts in order to become registered merchants with the host website. Web store front 153 provides an interface designed to enable a non-registered merchant to register with the host website. Information such as the merchant's username and password may be required input fields, which are to be provided by a non-registered merchant via the account creation page 154. The inputted information may be stored in merchant account database 155, which functions similar to the merchant account information 122 described above in FIG. 1A. The merchant account creation interface 156 provides a display page interface that displays whether or not the merchant successfully registered with the host website.

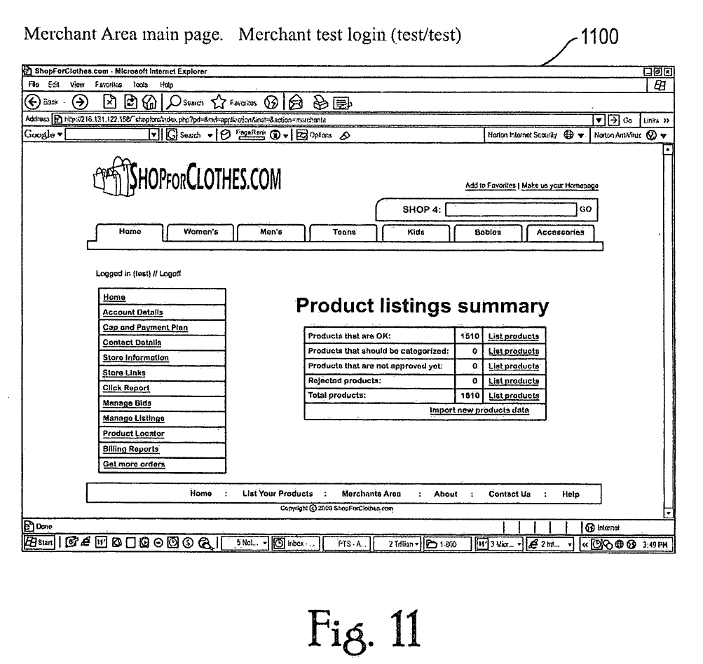

FIG. 10 illustrates a merchant login interface 1000 that provides a login interface to registered merchants. Interface 1000 allows the registered merchant to enter required information needed to successfully log on to the host website such as username, password, email etc. It is contemplated that other fields or information may be requested from the merchant. Information received from the merchant is transmitted via the network and authenticated in order to provide a registered merchant with access to the host website.

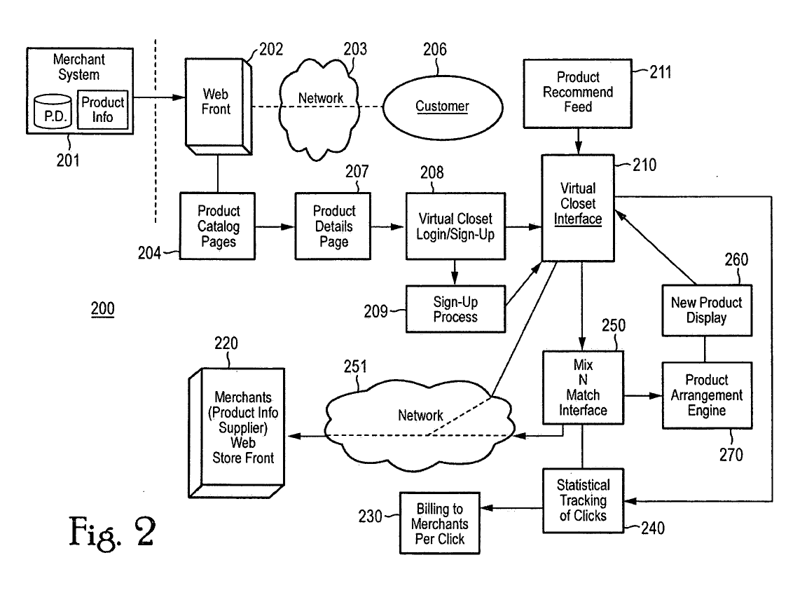

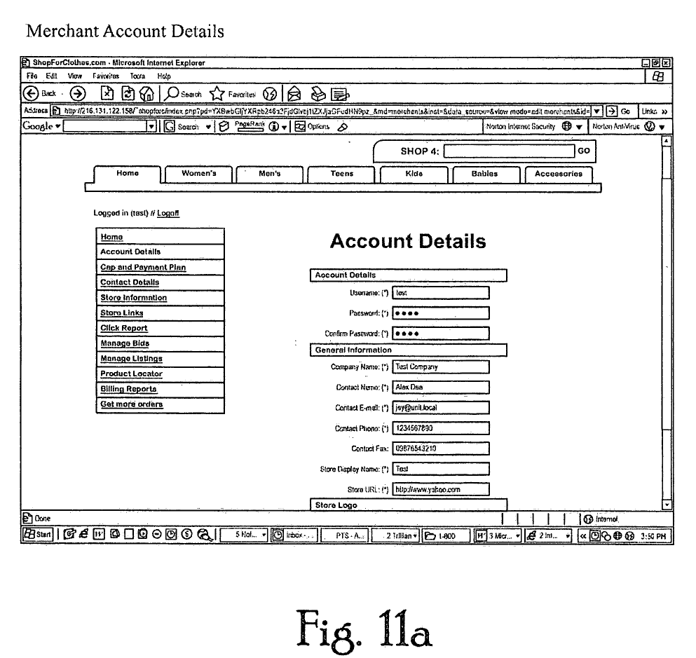

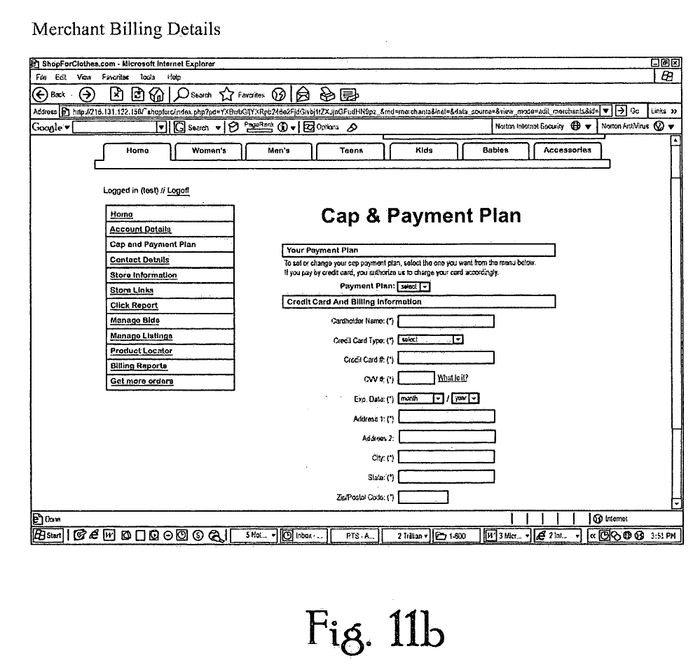

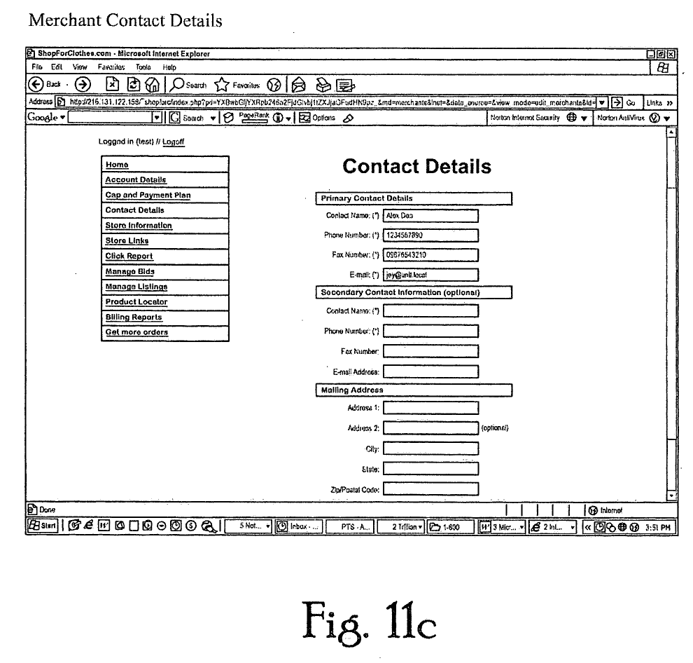

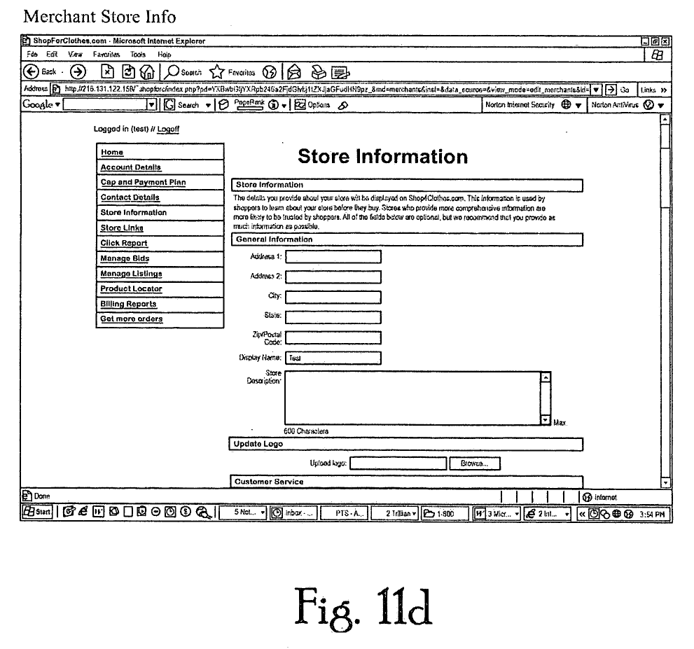

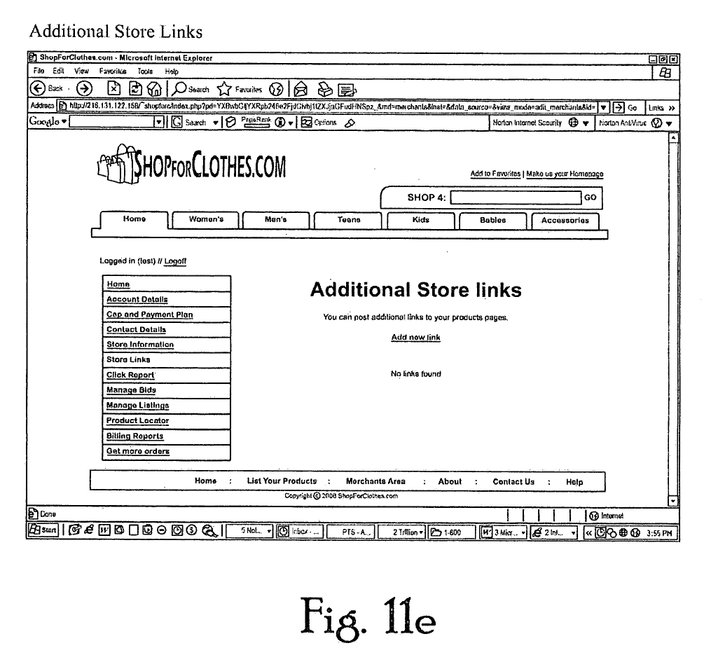

FIG. 11 illustrates a merchant area main page interface 1100 that, in this embodiment, is customized for a particular merchant. The host website can provide a similar interface to other registered merchants of the host website. The merchant area main page interface 1100 provides information related to, for example, a summary of the products that the registered merchant has registered with the host website. As shown, merchant area main page interface 1100 represents an example of the merchant control panel 113 described in FIG. 2. Interface 11100 contains information related to the total number of the products the merchant has on the host website system, the number of rejected products, the number of products on the system that are viable, the number of products that need to be categorized, and the number of products that are awaiting approval from the product submission administrator. In a particular embodiment, interface 1100 provides the registered merchant with access to the merchant's account details, cap and payment plan, contact details, store information, store links, click report, bid management, listings management, product locator, billings reports and a link to place more orders. FIGS. 11(a)-11(e) illustrate examples of interfaces a merchant sees when he/she clicks on information related to account details, cap and payment plan, contact details, store information and store links, respectively. Further, toolbars featuring the possible demographics of the customers, such as “women's”, “men's”, “teens”, “kids”, “babies” and “accessories” are provided in interface 1100. These toolbars offer a primary method of allowing users to navigate the host website system in order to find products of interest. Moreover, the host website contemplates a dynamic interface employing functionality such as hypertext links to provide interactive access to the interface. Once a category is clicked, information related to the clicked product is readily accessible to the merchant.

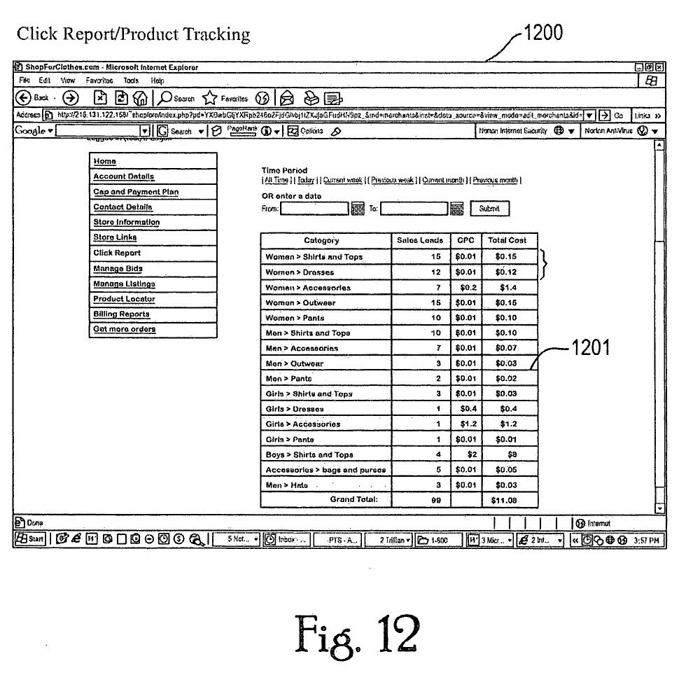

FIG. 12 illustrates an example of a product tracking interface 1200 that enables merchants to interactively track the number of clicks received by their products on to the host website. Product tracking interface 1200 allows merchants to enter a time frame in which they desire to track their product information. By entering such information, Table 1201 is created and populated with information that corresponds to the merchant's products. Merchants are billed by the host website based on the number of clicks each merchant's product receives. A pay-per-click system that is based on the bid amount may be used by the host website. The minimum cost per click (CPC) illustrated in this system is $0.01. For example, as shown in Table 1201, the sales leads for boys shirts and tops is 4, and the CPC is $2. Therefore, the total cost to the merchant is $8. Such methodology in calculating the cost per product is executed for all products loaded onto the host website wherein a final grand total may be billed to the merchant. Merchant account information 122 keeps track of information contained in product tracking 119 as well as pertinent personal information related to each merchant such as billing addresses.

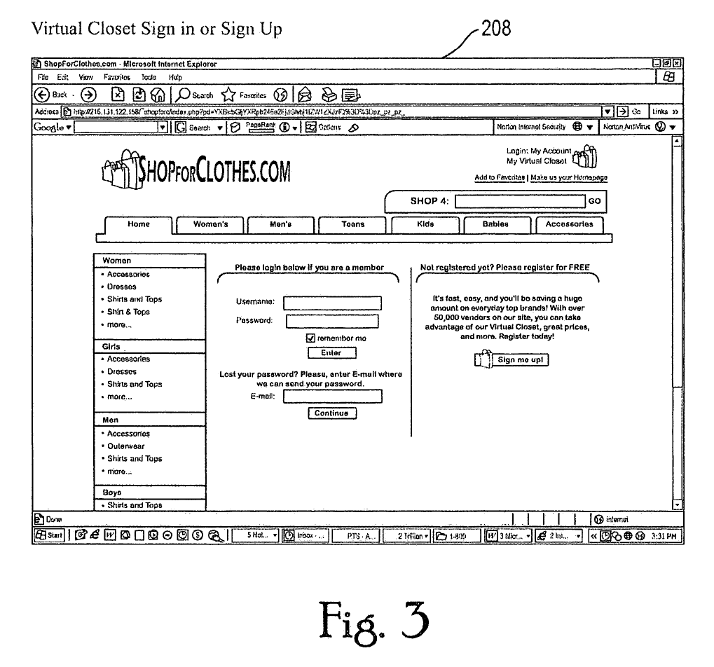

FIG. 2 is a conceptual system diagram for implementing the virtual closet method and system. Merchant system 201 includes product information that has been cataloged, arranged and stored within the product master database 114. The stored database information is loaded onto the virtual closet system 200 via web front 202 interface in order to be accessible to a customer 206 who logs onto the virtual closet system 200 via the network 203. Network 203 may be any collection and arrangement of hardware and/or software allowing electronic communications between components. For example, network 203 may be one or a collection of components associated with the public switched telephone network, local area networks, wide area networks, a global computer network such as the Internet, the World Wide Web, or any other suitable wireline or wireless communications technology. Web front 202 provides the interface that enables a customer 206 navigate through to the product catalog pages 204. Product catalog pages 204 enables a plurality of products to be categorized based on, for example, men, women, girls and/or boys clothing. Subcategories may be available to further categorize products. For example, within the women's clothing category are subcategories such as “accessories”, “dresses”, “shirts and tops” and “more . . . ”. By clicking on any of these subcategories, a customer is directed to product detail pages 207, which contains detailed descriptions of the clicked product. Product detail pages 207 may also include a virtual closet button that provides a link to virtual closet login 208. Virtual closet login 208 is provided for security purposes since the host website stores personal and confidential information of customers and merchants. More details with respect to FIG. 2 are provided below with reference to exemplary illustrated interfaces shown in FIGS. 3-12.

FIG. 3 illustrates a virtual closet login interface 208 that, in this embodiment, is customized based on information required by the host website. FIG. 3 illustrates a login interface for registered members. Virtual closet login interface 208 may request information from a customer relating to the customer's username, password, email address, gender, age group (i.e., adult or teen) etc. Virtual closet login 208 may also contain a “sign me up” button. In an embodiment of the invention, clicking the “sign me up” button enables an unregistered member within the virtual closet login interface 208 to be directed to sign-up process 209 as illustrated in FIG. 2.

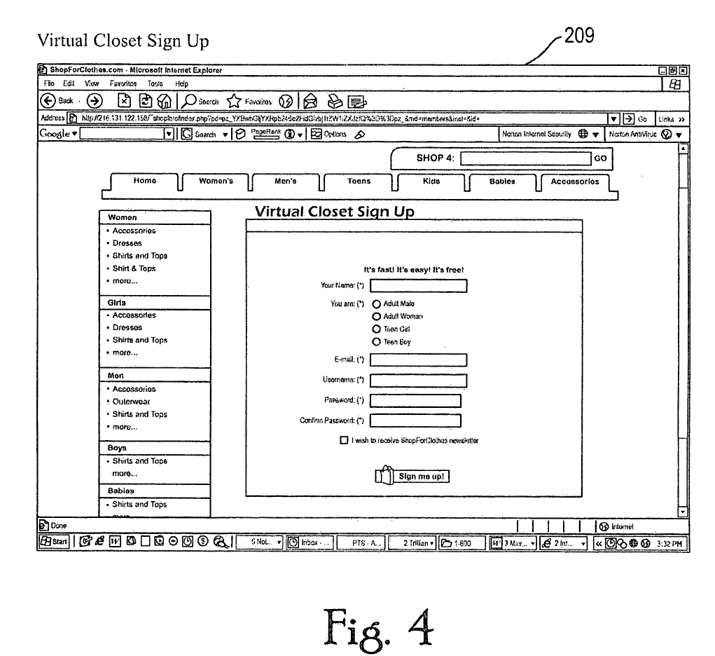

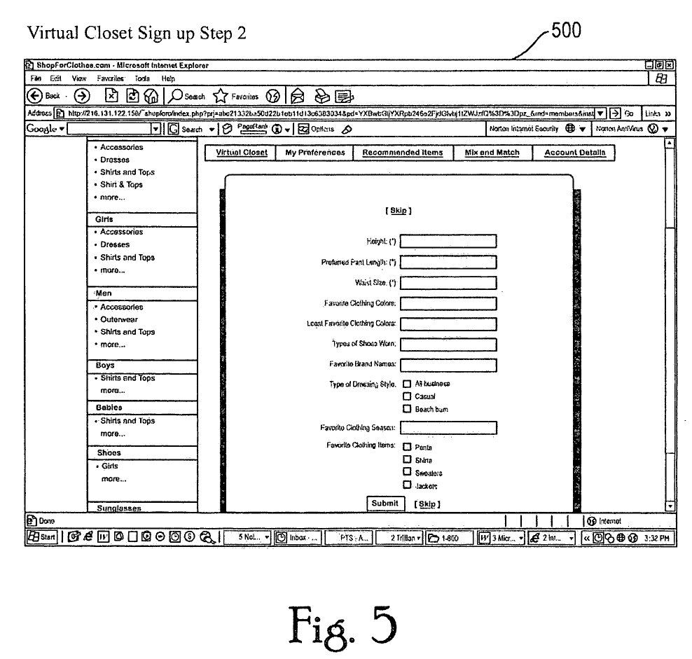

FIG. 4 illustrates a sign-up process interface 209 for non-registered members to become registered members. Sign-up process interface 209 may request information from a customer relating to the customer's name, username, password, email address, gender, age group (i.e., adult or teen) etc. After entering the required information, the user may be directed to a second page of the sign-up process interface 209.

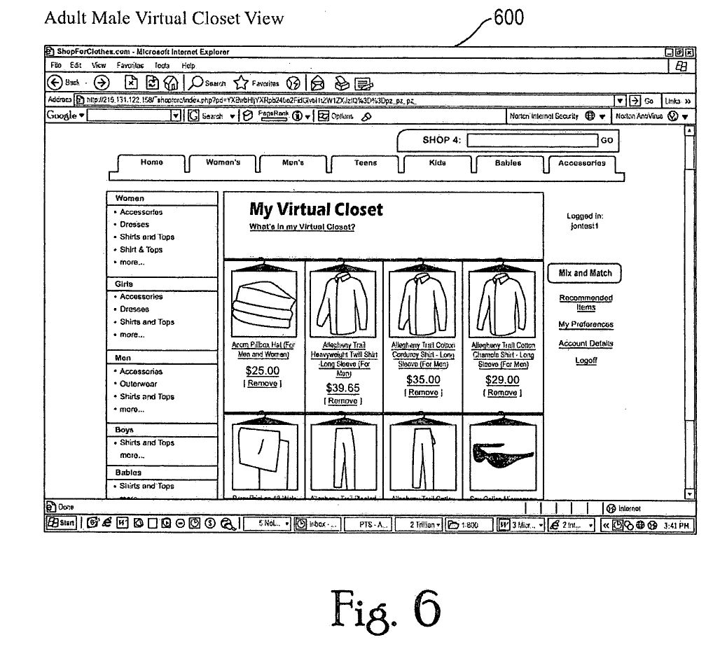

FIG. 5 illustrates an example of computer graphical user interface screen shot 500 representing a second page of the sign-up process interface 209, which requests further information from the customer in order to hone in on the customer's particular shopping needs. For example, virtual closet signup interface 500 may request information related to a customer's height, preferred paint length, waist size, favorite clothing colors, least favorite clothing colors, types of shoes worn, favorite brand names, type of dressing style, favorite clothing season, favorite clothing items and/or the like. Such information may be stored within the host website so that a regular user of the host website would not have to provide similar information the next time the user logs on to the system. The customer is directed to virtual closet interface 210, as shown in FIG. 2, after successfully completing the sign up process 209. A previously registered customer 206 may bypass sign up process 209 and get directed to virtual closet interface after the registered customer 206 successfully logs in on screen of FIG. 3. Virtual closet interface 210 initially contains the information associated with the customer as identified by the host website during the virtual closet login 208 and/or sign-up process 209.

FIG. 6, for example, illustrates a screen shot of the virtual closet interface 210 for a male customer wherein the male customer's profile is identified during the virtual closet login 208 and/or sign-up process 209 process. As shown in FIG. 6, the virtual interface window 600 contains information that corresponds to a male customer based on information previously supplied by the customer during the virtual closet login 208 and/or sign-up process 209 process. For example, virtual interface window 600 displays products such as Allegheny Trail Cotton for men that are further categorized as heavyweight twill shirts, corduroy shirt and chamois shirt. Further included in the products that may be displayed on virtual interface window 600 are pants of different styles, sunglasses, shoes and the like. These products may also be placed in the virtual closet by the user. The user has the flexibility of selecting other desired products from product catalog pages 204 and/or product details page 207, to be placed in his/her virtual closet.

In an embodiment of the invention, products recommended feed 211 automatically places products into a customer's virtual closet 210 based on the customer's profile and preferences as identified in the virtual closet login 208, sign-up process 209 process and/or by previous selections made. Product arrangement engine 270 interacts with new product display 260 to determine products the customer has failed to preview, and which of the non-previewed products are likely to be suitable to the customer's taste. Such products are determined and then directed into the customer's virtual closet 210. A shopping list is created on the virtual closet interface 210 within the host website. The shopping list allows a customer to assemble items within his/her virtual closet by moving different items within the virtual closet in order to seek desired matches of the different products. The ability to move products around within the virtual closet provide a user with an intelligent selection instead of guessing whether the products match. The shopping list provides users with the flexibility of placing items into the list and/or removing items from the list at their will. Access to respective shopping lists are limited to registered customers.

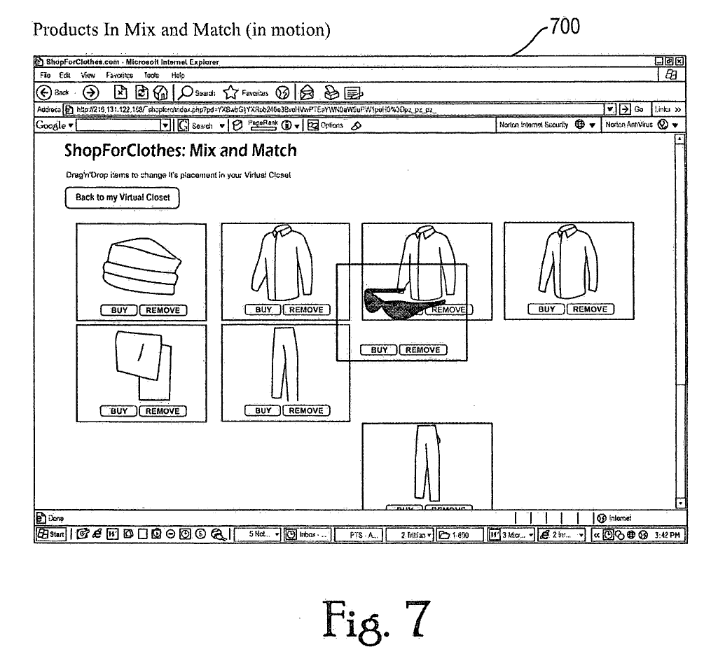

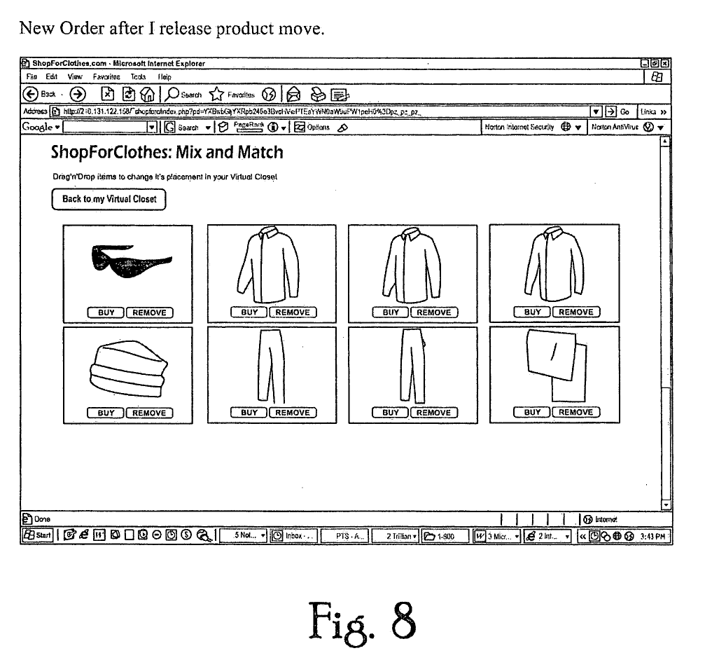

FIG. 7 illustrates a mix-n-match interface 700, corresponding to mix-n-match interface 250 in FIG. 2. Virtual interface 600 includes a “mix-n-match” conduit/button, which when activated or pressed directs a customer to the products displayed in the mix-n-match interface 700. The mix-n-match interface 700 contains products that can be clicked, held and dragged around the interface so as to be combined with other products to determine whether the various products match with one another. Programming tools such as AJAX may be used to design the click and drag operation. AJAX also functions as a product arrangement engine that facilitates the arrangement of various products in order to determine whether the products style, colors, material etc, match one another. It is contemplated that other programming tools may be used to achieved the results achieved by AJAX. FIG. 8 illustrates an example of a mix-n-match interface with the arrangement of products selected by a customer as a result of the mix-n-match process.

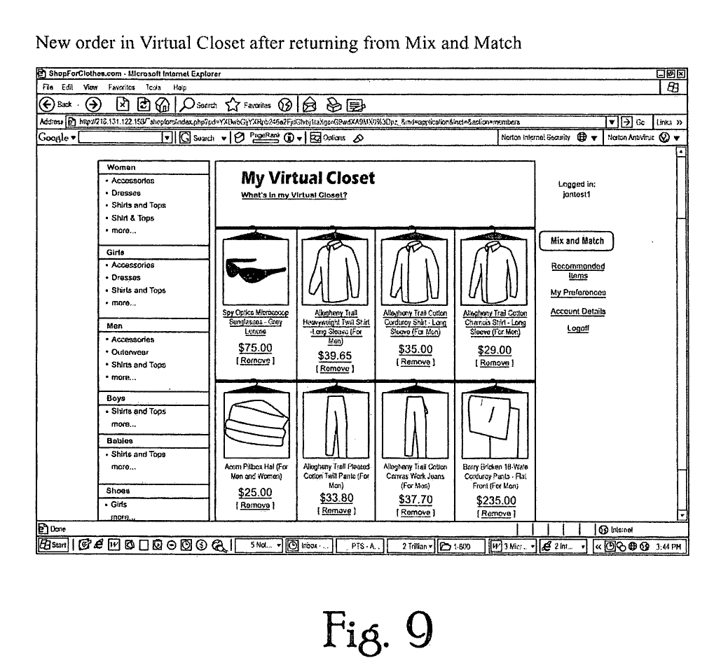

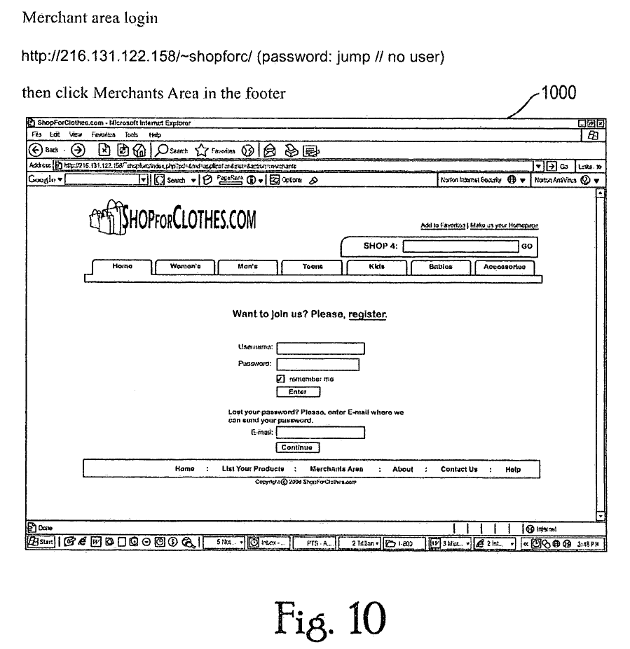

FIG. 9 illustrates an example of virtual closet interface 210, which displays its shopping list based on the last order and arrangement of products contained in the customers mix-n-match interface 250. Both virtual closet interface 210 and mix-n-match interface 250 include a “buy now” button. When a customer has selected desired products to be purchased at the host website, the customer may click on the “buy now” in order to complete the purchase process. By clicking the “buy now” button, the customer is directed, via network 251, to a merchant's personal website 220 associated with the clicked product. The merchant's personal website 220 is located external to the host website. A customer willing to purchase a merchant's product may then purchase the product at the merchant's website. However, the customer shops exclusively within the host website. Customers are directed to a merchant's external website only when the customers decide to purchase the merchant's product(s). All products available for sale that are offered to a customer within the host website are exclusively products that were previously submitted and registered with the host website.

Statistical tracking of clicks 240 keeps record of the number of clicks on products and “buy now” clicks made by customers. The host website then bills the merchants and vendors based on a calculated total number of clicks associated with each merchant. In FIG. 2, billing to merchant per click 230 records such number of clicks associated with each merchant and the corresponding monetary value to be billed each merchant. Merchants pay the proprietors of the host website each time their item is clicked, and when a user is directed to the merchant's website. Revenue stream to the proprietors of the host website are based on merchants who presubmitted their products, and not from customers who are shopping on the host website.

While the present invention has been described in connection with the illustrated embodiments, it will be appreciated and understood that modifications may be made without departing from the spirit and scope of the invention.

What is claimed is:

1. A method of shopping between customers and merchants within a host website connected on a computer network, comprising:
registering at least one of a plurality merchants and at least one of a plurality of customers within the host website;
categorizing products associated the registered merchants based on features corresponding to prospective registered customers;
storing the categorized products associated with the registered merchants in a storage medium connected to the host website;
transmitting the stored products via the computer network to a display interface, the display interface configured to be accessible by at least one of the registered customers; and
permitting the at least one of a plurality of registered customers to access the transmitted products of registered merchants, wherein the host website is configured to limit products available to registered customers to those of registered merchants.

2. The method of claim 1, wherein the categorizing comprises using software mechanisms to format information related to the registered merchants products.

3. The method of claim 1, further comprising:
tracking the number of access to the transmitted products of registered merchants made by the registered customers, the tracking configured to be based on the number of clicks received by products associated with each registered merchant.

4. The method of claim 3, further comprising:
calculating the total number of clicks received by each registered merchant; and
billing each merchant based on the calculated total.

5. The method of claim 1, wherein the storing comprises accessing a database, read-only memory and/or random access memory.

6. A method of shopping between customers and merchants within a host web site connected on a computer network, comprising:
registering at least one of a plurality merchants and at least one of a plurality of customers within the host website;
assigning a personal interface to each of the registered customers, wherein the personal interface is connected to a storage medium allocated to each of the registered customers;
identifying information associated with each of the registered customers based on information inputted to the host website by the each customer during registration/signup with the host website; and
automatically placing products associated with registered merchants in the personal interface of registered customers corresponding to the information inputted to the host website by each customer during registration/signup.

7. The method of claim 6, wherein the personal interface assigned to each registered customer is configured to enable each registered customer to assemble a plurality of products within their respective personal interface by moving products around in order to determine which of the plurality of products match one another.

8. The method of claim 6, wherein the host website continuously stores a last image displayed on the registered customer's interface within the storage medium.

9. The method of claim 6, further comprising:
tracking the number of accesses to placed products of registered merchants made by the registered customers, the tracking configured to be based on the number of clicks received by placed products associated with each registered merchant.

10. The method of claim 9, further comprising:
calculating the total number of clicks received by each registered merchant; and
billing each merchant based on the calculated total.

11. The method of claim 8, wherein the storage medium comprises a database, read-only memory and or random access memory.

12. An shopping system within a host website connected on a computer, comprising:
a registration mechanism for registering at least one of a plurality merchants and at least one of a plurality of customers within the host website;
a categorizing mechanism for categorizing products associated the registered merchants based on features corresponding to prospective registered customers;
a storage mechanism for storing the categorized products associated with the registered merchants in a storage medium connected to the host website;
a transmitting mechanism for transmitting the stored products via the computer network to a display interface, the display interface configured to be accessible by at least one of the registered customers; and
an authentication mechanism for permitting the at least one of a plurality of registered customers to access the transmitted products of registered merchants, wherein the host website is configured to limit products available to registered customers to products of registered merchants.

13. A shopping system, comprising:
a registration mechanism for registering at least one of a plurality merchants and at least one of a plurality of customers within the host website;
an assigning mechanism for assigning a personal interface to each of the registered customers, wherein the personal interface is connected to a storage medium allocated to each of the registered customers;
an identifying mechanism for identifying information associated with each of the registered customers based on information inputted to the host website by the each customer during registration/signup with the host website; and
an automated placement mechanism for automatically display products associated with registered merchants in the personal interface of registered customers, the displayed products correlated to the information inputted to the host website by each customer during registration/signup,
wherein the host website is configured to limit products available to registered customers to products of registered merchants.

14. The system of claim 13, wherein the personal interface assigned to each registered customer is configured to enable each registered customer to assemble a plurality of products within their respective personal interface by moving products around in order to determine which of the plurality of products match one another.

15. The system of claim 13, wherein the host website continuously stores a last image displayed on the registered customer's interface within the storage medium.

16. The system of claim 13, further comprising:
a tracking mechanism for tracking the number of access to placed products of registered merchants made by the registered customers, the tracking configured to be based on the number of clicks received by placed products associated with each registered merchant.

17. The system of claim 16, further comprising:
a calculating mechanism for calculating the total number of clicks received by each registered merchant; and
a billing mechanism for billing each merchant based on the calculated total.

18. The system of claim 15, wherein the storage medium comprises a database, read-only memory and/or random access memory.

19. A method of shopping between customers and merchants within a host website connected on a computer network, comprising:
registering at least one of a plurality merchants and at least one of a plurality of customers within the host website;
loading registered merchants products on to the host website; and
shopping exclusively on the host website by registered customers, the shopping configured to be based on the loaded products of registered merchants.

20. The method of claim 19, further comprising:
directing the registered customer to an external website associated with a registered merchant to facilitate the registered customer to purchase at least one of the loaded products associated with the registered merchant.

21. The method of claim 19, further comprising:
permitting a registered customer to assemble a plurality of products associated with registered merchants;
storing the assembled products in a personalize storage medium associated with the registered customer;
moving a plurality of the stored products around within the storage medium in order to decide whether the stored products match; and
displaying the moving products in an output device.

22. The method of claim 21, further comprising:
automatically placing products associated with registered merchants into the personalize storage medium associated with the registered customer based on the registered customer's profile and preferences as identified during the registration of the customer.

23. The method of claim 21, further comprising:
determining products the registered customer failed to preview;
filtering products from the determined products that are estimated to be suitable for the registered customer; and
transmitting the filtered products to the personalize storage medium associated with the registered customer.

24. The method of claim 19, further comprising:
controlling the placement of products placed on the host website based on the registered merchants bidding on advertisement placements within the host website; and
selecting advertisement placements directed to registered customers to the advertisement placement that receives the highest bid.

25. The method of claim 1, further comprising:
directing the registered customer to an external website associated with a registered merchant to facilitate the registered customer to purchase at least one of the loaded products associated with the registered merchant.

26. The method of claim 1, further comprising:
permitting the registered customer to assemble a plurality of products associated with registered merchants;
storing the assembled products in a personalize storage medium associated with the registered customer;
moving a plurality of the stored products around within the storage medium in order to decide whether the stored products match; and
displaying the moving products in an output device.

27. The method of claim 26, further comprising:
automatically placing products associated with registered merchants into the personalize storage medium associated with the registered customer based on the registered customer's profile and preferences as identified during the registration of the customer.

28. The method of claim 27, further comprising:
determining products the registered customer failed to preview;
filtering products from the determined products that are estimated to be suitable for the registered customer; and
transmitting the filtered products to the personalize storage medium associated with the registered customer.

29. The method of claim 1, further comprising:
controlling the placement of products placed on the host website based on the registered merchants bidding on advertisement placements within the host website; and
selecting advertisement placements directed to registered customers to the advertisement placement that receives the highest bid.

30. The method of claim 6, further comprising:
directing the registered customer to an external website associated with a registered merchant to facilitate the registered customer to purchase at least one of the loaded products associated with the registered merchant.

31. The method of claim 6, further comprising:
permitting a registered customer to assemble a plurality of products associated with registered merchants;
storing the assembled products in a personalize storage medium associated with the registered customer;
moving a plurality of the stored products around within the storage medium in order to decide whether the stored products match; and
displaying the moving products in an output device.

32. The method of claim 31, further comprising:
automatically placing products associated with registered merchants into the personalize storage medium associated with the registered customer based on the registered customer's profile and preferences as identified during the registration of the customer.

33. The method of claim 32, further comprising:
determining products the registered customer failed to preview;
filtering products from the determined products that are estimated to be suitable for the registered customer; and
transmitting the filtered products to the personalize storage medium associated with the registered customer.

34. The method of claim 6, further comprising:
controlling the placement of products placed on the host website based on the registered merchants bidding on advertisement placements within the host website; and
selecting advertisement placements directed to registered customers to the advertisement placement that receives the highest bid.

35. The system of claim 13, further comprising:
a purchasing mechanism for directing the registered customer to an external website associated with a registered merchant to facilitate the registered customer to purchase at least one of the loaded products associated with the registered merchant.

36. The system of claim 13, further comprising:
an assembling mechanism for permitting a registered customer to assemble a plurality of products associated with registered merchants;
a storing mechanism for storing the assembled products in a personalize storage medium associated with the registered customer;
a movement mechanism for moving a plurality of the stored products around within the storage medium in order to decide whether the stored products match; and
a display mechanism for displaying the moving products in an output device.

37. The system of claim 36, further comprising:
a placement mechanism for automatically placing products associated with registered merchants into the personalize storage medium associated with the registered customer based on the registered customer's profile and preferences as identified during the registration of the customer.

38. The system of claim 37, further comprising:
a determining mechanism for determining products the registered customer failed to preview;
a filtering mechanism for filtering products from the determined products that are estimated to be suitable for the registered customer; and
a transmitting mechanism for transmitting the filtered products to the personalize storage medium associated with the registered customer.

39. The system of claim 13, further comprising:
a control mechanism for controlling the placement of products placed on the host website based on the registered merchants bidding on advertisement placements within the host website; and
a selecting mechanism for selecting advertisement placements directed to registered customers to the advertisement placement that receives the highest bid.
